(19) United States
(12) Patent Application Publication
(10) Pub. No.: US 2026/0260519 A1
(43) Pub. Date: Sep. 3, 2026

(54) METHOD, APPARATUS, DEVICE AND STORAGE MEDIUM FOR SIGNAL PROCESSING

(71) Applicants: Lemon Inc., Grand Cayman (KY); Beijing Zitiao Network Technology Co., Ltd., Beijing (CN)

(72) Inventors: Bowei ZHANG, Los Angeles, CA (US); Runyu LIU, Los Angeles, CA (US); Xiaokai LI, Beijing (CN)

(21) Appl. No.: 19/143,770

(22) PCT Filed: Feb. 28, 2024
(86) PCT No.: PCT/CN2024/078952

§ 371 Date: Jun. 26, 2025

(30) Foreign Application Priority Data
Mar. 2, 2023 (CN) 202310194585.4

(51) Int. Cl. G06V 40/50; G06V 40/18; G06V 40/19

(52) U.S. Cl. CPC G06V 40/53; G06V 40/19; G06V 40/193

(57) ABSTRACT

According to embodiments of the disclosure, a method, apparatus, device and storage medium for signal processing are provided. The method includes capturing, using a camera, a first image for a first portion of a user, the first image having a first precision; performing biometric-based identity verification on the user using information of the first portion comprised in the first image; and in response to the identity verification being passed, obtaining at least one second image for a second portion of the user, the at least one second image having a second precision different from the first precision.

This application claims the benefit of Chinese Patent Application No. 202310194585.4, entitled “METHOD, APPARATUS, DEVICE AND STORAGE MEDIUM FOR SIGNAL PROCESSING” filed Mar. 2, 2023, the entire content of which is incorporated herein by reference.

### FIELD

Example embodiments of the present disclosure generally relate to the field of computers, and in particular, to a method, apparatus, device, and computer-readable storage medium for signal processing.

### BACKGROUND

In the informatization era, in many cases, such as when using specific devices or entering certain occasions, it is necessary to collect user data in order to perform identity recognition and verification on users. How to accurately identify a person's identity and protect their privacy and data security is a problem that must be concerned and solved.

### SUMMARY

In a first aspect of the present disclosure, a method of signal processing is provided. The method includes capturing, using a camera, a first image for a first portion of a user, the first image having a first precision; performing biometric-based identity verification on the user using information of the first portion comprised in the first image; and in response to the identity verification being passed, obtaining at least one second image for a second portion of the user, the at least one second image having a second precision different from the first precision.

In a second aspect of the present disclosure, an apparatus for signal processing is provided. The apparatus includes: a first image capturing module configured to capture, using a camera, a first image for a first portion of a user, the first image having a first precision; an identity verification module configured to perform biometric-based identity verification on the user using information of the first portion comprised in the first image; and a second image obtaining module configured to in response to the identity verification being passed, obtain at least one second image for a second portion of the user, the at least one second image having a second precision different from the first precision.

In a third aspect of the present disclosure, a wearable device is provided. The wearable device includes: a camera; and a controller configured to: capture, using a camera, a first image for a first portion of a user, the first image having a first precision; perform biometric-based identity verification on the user using information of the first portion comprised in the first image; and in response to the identity verification being passed, obtain at least one second image for a second portion of the user, the at least one second image having a second precision different from the first precision.

In a fourth aspect of the present disclosure, there is provided an electronic device. The device includes at least one processing unit; and at least one memory coupled to the at least one processing unit and storing instructions executable by the at least one processing unit. The instructions, when executed by the at least one processing unit, cause the device to perform the method of the first aspect.

In a fifth aspect of the present disclosure, there is provided a computer readable storage medium having stored thereon a computer program executable by a processor to implement the method of the first aspect.

It should be understood that the content described in the SUMMARY section is neither intended to limit key features or important features of embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent with reference to the following DETAILED DESCRIPTION and in conjunction with the accompanying drawings. In the drawings, the same or similar reference numerals refer to the same or similar elements, wherein:

FIG. 1 illustrates a schematic diagram of an example environment in which the embodiments of the present disclosure can be implemented;

FIG. 2 illustrates a flowchart of an example process of signal processing according to some embodiments of the present disclosure;

FIG. 3 illustrates a schematic diagram of an example device for signal processing according to some embodiments of the present disclosure;

FIG. 4 illustrates a flowchart of a process of signal processing according to some embodiments of the present disclosure;

FIG. 5 illustrates a block diagram of an apparatus for signal processing according to some embodiments of the present disclosure;

FIG. 6 illustrates a schematic diagram of an example of a wearable device according to some embodiments of the present disclosure; and

FIG. 7 illustrates a block diagram of a device capable of implementing various embodiments of the present disclosure.

### DETAILED DESCRIPTION

It can be understood that, before using the technical solutions disclosed in the implementations of the present disclosure, the user should be notified of the type, the use range, the use scenario, and the like of the personal information involved in the present disclosure and authorized by the user in an appropriate manner according to related laws and regulations.

For example, when an active request of a user is received, prompt information is sent to the user to explicitly prompt the user, and an operation requested to be performed by the user needs to obtain and use personal information of the user. Therefore, the user can autonomously select, according to the prompt information, whether to provide personal information to software or hardware such as an electronic device, an application, a server or a storage medium that performs the operations of the technical solutions of the present disclosure.

As an optional but non-limiting implementation manner, in response to receiving an active request of the user, a manner of sending prompt information to the user, for example, a manner of popping up a window, the pop-up window may present the prompt information in a text manner. In addition, the pop-up window may further carry a selection control for the user to select “agree” or “disagree” to provide personal information to the electronic device.

It can be understood that the foregoing process of notifying and acquiring user authorization is merely illustrative and does not constitute a limitation on the implementations of the present disclosure, and other manners that meet related laws and regulations may also be applied to the implementations of the present disclosure.

It can be understood that data (including but not limited to the data itself, the acquisition or use of the data) involved in this technical solution should comply with requirements of corresponding laws and regulations and related rules.

The embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for illustrative purposes and are not intended to limit the scope of protection of the present disclosure.

It should be noted that titles of any section/subsection provided herein are not limiting. Various embodiments are described throughout this document, and any type of embodiment may be included under any section/subsection. Moreover, the embodiments described in any section/subsection may be combined in any manner with any other embodiments described in the same section/subsection and/or different section/subsection.

In the description of the embodiments of the present disclosure, the term “include” and similar terms should be understood as open inclusion, that is, “include but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or the same objects. Other explicit and implicit definitions may also be included below.

As mentioned briefly above, in some devices, user data needs to be collected when certain specific functions are performed. If the device is hacked or stolen, the collected biometric information may be stolen. This may compromise personal privacy and data security for users and may cause serious harm to the reputation of the company.

Traditional identity verification is increasingly difficult to meet the needs of society due to extremely easy counterfeiting and loss. Biometric identification is a technique for authenticating a personal identity through physiological features or behavioral features inherent to a human body. It does not require the user to carry any certificate, or remember any password, which is a very convenient, fast and secure recognition technology.

Embodiments of the present disclosure provide a solution for signal processing. According to various embodiments of the present disclosure, a first image for a first portion of a user is captured using a camera. Biometric-based identity verification is performed on the user using information of the first portion included in the first image. If the identity verification of the user is passed, a second image for a second portion of the user is obtained. The second image has a second precision that is different from a first precision that the first image has. Therefore, identity verification is performed on the user based on the biometric feature recognition technology, and data that may be used or requested by the device may be provided. Different precision images are obtained for different functions, so that the image processing efficiency may be improved, and the dual protection of personal privacy and data security of the user may be realized.

Example embodiments of the present disclosure are described below with reference to the accompanying drawings.

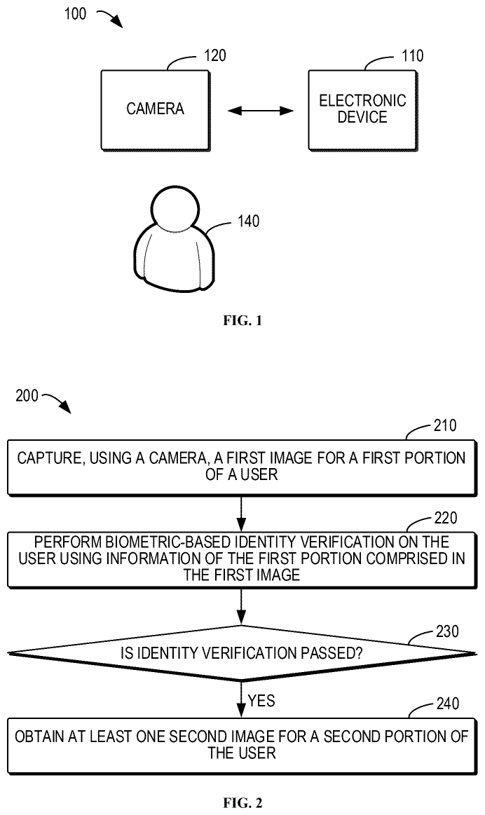

FIG. 1 illustrates a schematic diagram of an example environment 100 in which embodiments of the present disclosure may be implemented. In the environment 100, the electronic device 110 may be any computing enabled device. The electronic device 110 may be implemented in a controller or a processor. The electronic device 110 may communicate with the camera 120 in a suitable manner to capture images of the user 140 using the camera 120. The images captured by the camera 120 may include images for some or certain body portions of the user 140, including, for example, faces, eyes, hands, and the like. The electronic device 110 receives and processes such images.

The electronic device 110 and the camera 120 may be arranged in different devices, for example, the camera 120 is arranged in a terminal device, and the electronic device 110 is arranged in a background server. The electronic device 110 and the camera 120 may also be arranged in the same device. Such a device may be a terminal device, such as a personal computer, a tablet computer, a mobile phone, a punched-card machine, and the like. Such a device may also be a wearable device, such as AR/VR/MR glasses, assistive glasses, and the like.

In some embodiments, the camera 120 may be an infrared camera or a camera including an infrared filter. Correspondingly, the device including the camera 120 further includes an infrared light source for illuminating the body portion of the user 140, so that the camera 120 captures an image for the portion.

It should be understood that the structure and function of the environment 100 is described for example purposes only and does not imply any limitation to the scope of the present disclosure.

Some example embodiments of the present disclosure will be described below with continued reference to the accompanying drawings.

FIG. 2 illustrates a flowchart of an example process 200 for signal processing in accordance with some embodiments of the present disclosure. The example process 200 may be implemented at the electronic device 110. The example process 200 is described below with reference to FIG. 1.

At block 210, the electronic device 110 captures a first image of a first portion of the user 140 with the camera 120. In some embodiments, the first portion of the user 140 may correspond to a certain or some body portions of the user, such as eyes, faces, hands, and the like. Other portions are also possible, and the scope of the present disclosure is not limited in this respect.

The first image may be a static picture of the portion of the user, or may be a dynamic image, that is, a video. As described below, the first image is used to perform identify recognition for the user. Therefore, it is necessary to ensure that enough information is included in the first image. Therefore, according to an embodiment of the present disclosure, a first precision of the first image is usually a higher precision, for example, higher than a predetermined threshold precision.

The precision measures the clarity of the image and the richness of the contained information. The clearer the image, the richer information is contained, and the higher the precision is.

In some embodiments, image precision may be represented by pixel precision. Pixel precision is the actual physical size represented by each pixel in the image. The larger the pixel precision, the lower the image precision. In some embodiments, image precision may be expressed in resolution. Resolution refers to how many pixels are arranged in unit length. For the same size field of view, the higher the resolution, the higher the precision of the obtained image, the more obvious the display of detail.

In some embodiments, the first image includes information of a predetermined type. In particular, the information of the predetermined type may be information related to physiological features. For example, if the first image is an image of an eye of the user, the information of the predetermined type includes the color of the iris, the size of the pupil, and the like. Additionally, or alternatively, in some embodiments, the information of the predetermined type may also be information related to the behavior feature. For example, still taking the image of the user's eyes as an example, the information of the predetermined type includes blinking, frowning, etc.

In some embodiments, the information of the predetermined type is information for biometric identification of the user. The information that may be used for biometric identification includes face type, fingerprint, palm print, retina, iris, and the like.

At block 220, the electronic device 110 performs biometric-based identity verification on the user 140 using information of the first portion included in the first image.

As an example, as described above, in some embodiments, the first image includes facial information of the user 140. In such an embodiment, the electronic device 110 quantifies a series of parameters through a distance, an angle, a size, a shape, or the like between a facial feature and a facial organ, so as to perform identity verification on the user 140.

Since the first precision of the first image is relatively high, the information included in the image that may be used for identity recognition and identity verification is also relatively rich. This helps to ensure improved precision and/or speed of user identity recognition.

For example, in some embodiments, the first image includes eye pattern information of the user 140. The electronic device 110 performs identity verification on the user 140 by identifying the vein vascular texture in the white region of the eyes. As another example, in some embodiments, the first image includes retina information of the user 140. The electronic device 110 performs identity verification on the user 140 through the features of the retina. As still another example, in some embodiments, the first image includes iris information of the user 140. The electronic device 110 performs identity verification on the user 140 by identifying features such as spots, stripes, crowns, filaments and the like of the iris.

At block 230, the electronic device 110 determines whether the identity verification of the user is passed. If the identity verification of the user 140 is passed, the example process 200 proceeds to block 240. If not, the electronic device 110 may prompt the user by way of image, text, voice, alarm sound, etc., and refuse to provide use of the device. The device herein refers to a device that needs to be used by identity verification. It may be a device including the electronic device 110 or the camera 120 or both, or a device independent of the electronic device 110 or the camera 120.

At block 240, the electronic device 110 obtains at least one second image for a second portion of the user. The second portion of the user 140 is also a certain or some body portions of the user, such as eyes, faces, and the like. The second portion may be the same as or different from the first portion.

The first image captured by the electronic device 110 is used to perform identity verification on the user 140, and after the identity verification succeeds, the second image obtained by the electronic device 110 may be used to support other functions of the device. It should be understood that although descriptions of “first image” and “second image” are used, the order of obtaining the two images is not shown. For example, the electronic device 110 may first obtain a plurality of second images, and after the identity verification is performed on the user 140 based on the biometric feature information in the first image, the electronic device 110 may provide a device function based on the plurality of second images to the user 140 or provide data about the plurality of second images.

As an example, the user 140 wears a near-eye display device. The near-eye display device includes the electronic device 110 and the camera 120 as described above. The electronic device 110 captures an eye image for the user 140 with the camera 120. Using the iris information in the eye image, the electronic device 110 performs identity verification on the user 140. If the identity verification cannot be passed, the user 140 is not allowed to use the near-eye display device, thereby protecting personal privacy and data of the owner of the device.

If the identity verification may be passed, the user 140 is allowed to use other functions of the near-eye display device, such as entering a virtual reality scenario. In the virtual reality scenario, in order to track the eyes of the user 140 to determine a gaze direction of the user 140, the electronic device 110 collects a plurality of second images, for example, to determine the gaze direction based on a center position of the pupil, a center position of the iris, or a center position of the eyeball in the second image, thereby providing a better immersive experience for the user.

According to an embodiment of the present disclosure, the second image has a second precision different from the first precision of the first image. That is, the electronic device 110 obtains images with different precisions according to different requirements for the image precision based on the image precision.

For example, in the above example, the first image is used for identity verification, and the one or more second images are used for eye tracking of the user. In such embodiments, the first precision of the first image is higher than the second precision of the second image. In such an embodiment, not only may the processing efficiency of the second image be ensured, but also personal privacy and data of the user may be better protected by reducing user information in subsequent processing. For example, the user identity verification function requires an image containing more biometric feature information, and the electronic device 110 captures the first image with higher precision. The eye tracking function requires a faster processing speed and the electronic device 110 captures the second image with lower precision.

In the several examples described above and to be described below, for convenience of discussion, the first precision is described as being greater than the second precision. But this is merely an example and not mandatory or necessary. In other embodiments, subsequently captured second images may also be used for other uses requiring higher precision. For example, the second image is used for identity verification in an online payment scenario, and in this case, the second precision may be higher than the first precision.

Consider an example where the second image is used for eye tracking or similar use. At this time, the second image may have a lower image quality or contain less information. For example, in some embodiments, the second image has a lower resolution than that of the first image. For example, the captured first image is used for identity verification and has a higher resolution. After the identity verification of the user 140 is passed, the captured plurality of second images are used for micro expression capture, and for micro expressions such as blinking, frowning and pouting, only images with lower resolution are required to support the function.

In some embodiments, the one or more second images do not include a predetermined type of information as compared to the first image. For example, the first image with the first precision contains sufficient biometric information so that the electronic device 110 may verify the identity of the user. The second image with the second precision does not contain such information but contains information sufficient to support other functions. For example, for the eye movement tracking function, the second image includes diffuse reflection information of the pupil and light spot information of the cornea. Such a precision requirement enables the second image to not include a clear iris texture, thereby reducing the risk of user data leakage.

Again, note that in other embodiments, the resolution of the second image may also be higher than that of the first image; and/or the information contained in the second image may be richer than the first image. For example, returning to the example in which the user 140 wears the near-eye display device, the user 140 starts using the device after passing the identity verification. To enter a virtual place, the electronic device 110 needs to obtain a second image with a higher resolution for identity verification. If the security level of the virtual place is much higher than the security level of the near-eye display device, the resolution of the second image is higher than the resolution of the first image. The scope of the present disclosure is not limited in this respect. To obtain the second image at the second precision or obtain the second image that does not include the predetermined type of information, the electronic device 110 may control the camera 120 to capture the second image for the second portion of the user with a lower precision. The electronic device 110 may also control the camera 120 to obtain at least one original image for the second portion of the user at a higher precision, and then perform quality reduction (degradation) processing on the original image to generate the second image. The degradation processing includes blurring the original image, reducing pixel sampling, pixel interpolation, adding noise, and the like. Additionally, or alternatively, the electronic device 110 alters or degrades a partial region (e.g., an iris region) in the original image.

In some embodiments, the electronic device 110 arranges the camera 120 to capture the second image at a second precision. For example, the image sensor of the camera is configured to reduce the precision of the captured image by shielding a part of the pixels, thereby directly capturing the second image with lower precision.

In some embodiments, the electronic device 110 captures an original image for a second portion of the user at the first precision using the camera 120 and generates the second image by performing sampling on the original image to change image precision. For example, in an example in which the first precision of the first image is greater than the second precision of the second image, the obtained raw data of the second image may be sampled. The image sampling processing is to spatially segment a continuous image into M×N grids, each of which is represented by a brightness value or a grayscale value. The larger the interval of image sampling, the smaller the number of image pixels obtained, the lower the spatial resolution. Thus, the second image with a lower resolution is obtained.

In order to better protect the privacy of the user and data security, in some embodiments, the electronic device 110 may delete the first image after the identity verification based on the first image is completed. As described above, the first image may include biometric information of the user 140. If the device storing the first image is hacked or stolen, user data leakage may result. By deleting the first image after the identity verification is passed or completed, personal privacy and data of the user can be better protected.

In some embodiments, the camera 120 is arranged in a wearable device. In some embodiments, the wearable device further includes the electronic device 110. In some embodiments, the wearable device further includes a second camera 120. The two cameras 120 may respectively or collectively be implemented as the cameras 120 as described above. For example, a first image is captured by one of the cameras, a second image is captured by another camera, or used to generate an original image of the second image. For another example, the first image, the second image, or the original image used to generate the second image are synthesized by using images obtained by the two cameras respectively. For another example, one camera captures a first image, and second images are captured respectively through two cameras to obtain a plurality of second images. The present disclosure does not limit these implementations. Additionally, or alternatively, the camera 120 is arranged adjacent to an edge of a lens of the wearable device. The wearable device is, for example, a near-eye display device including a lens.

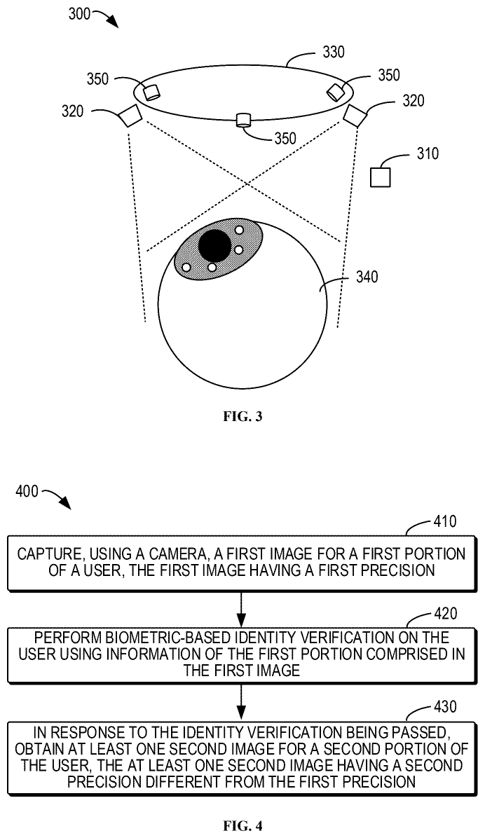

FIG. 3 illustrates a schematic diagram of an example device 300 for signal processing according to some embodiments of the present disclosure. The example device 300 may include the electronic device 110 and the camera 120 as described above. The example device 300 may also implement the functionality of the electronic device 110 and the camera 120 in different forms or structures. For example, an electronic device 310 in the example device 300 is implemented as or includes the electronic device 110, and a camera 320 in the example device 300 is implemented as or includes the camera 120.

In the example of FIG. 3, the example device 300 is a near-eye display device, including the electronic device 310, the camera 320, a light source 350, and a lens 330. The lens 330 is arranged in front of the eyeball 340 of the user 140, and the user 140 may, for example, see a virtual scenario or a real scenario superimposed of the virtual image through the lens 330. The camera 320 is arranged adjacent to an edge of the lens 330.

In some embodiments, the example device 300 includes one camera 320 and at least one light source 350. The camera 320 is arranged adjacent to the end of the lens 330 along a horizontal axis of the lens 330. The light source 350 is arranged adjacent to the edge of the lens 330.

In some embodiments, the example device 300 includes two cameras 320 and a plurality of light sources 350. The plurality of light sources 350 are arranged about the lens 330. The lens 330 may be a folded optical path lens or referred to as a pancake lens. Two cameras 320 are arranged adjacent to two ends of the lens 330 along the horizontal axis of the lens 330, respectively. For example, one camera 320 is arranged close to the inner side of the eye of the user 140, and the other camera 320 is arranged close to the outer side of the eye of the user 140. More biometric information, such as the radian of the cornea, may be obtained through images obtained by the two cameras. The position of the light spot on the cornea may be more accurately positioned based on the radian of the cornea, so that the precision of the eye movement tracking system is improved.

It should be understood that the hardware and structure of the example apparatus 300 as described above does not constitute a limitation on the signal processing scheme of the present disclosure. Devices including the electronic device 110 or the camera 120, or both, may be implemented in any suitable manner.

Returning to the example of FIG. 3, the electronic device 310 captures the first image for the eyeball 340 with the camera 320 at a higher first precision. The electronic device 110 preprocesses the first image, for example, iris positioning, iris image normalization, and image enhancement and the like. After the image preprocessing, the electronic device 310 extracts feature points in the image and encodes the feature points, and then matches the feature codes with feature codes for the pre-stored iris image one by one to determine whether the irises are the same, thereby completing the identity verification of the user 140 and realizing the first level protection of the user data. By adopting the iris recognition technology, identity verification may be accurately and quickly completed, and the user experience is improved. Additionally, or alternatively, the electronic device 310 supports iris recognition with only images for the left eye, images for the right eye, or images for both eyes.

In some embodiments, the camera 320 is an infrared camera, which may capture a first image used for identity verification or may capture a second image used for eye movement tracking, thereby achieving compatibility with the camera.

The electronic device 310 captures an original image of the eyeball 340 with the camera 320 at a second precision different from the first precision. Such an original image may also include biometric information of the user, and therefore, the electronic device 310 performs quality reduction processing on the original image to generate the second image. Such a second image does not include biometric information of the user 140.

In some embodiments, the second precision is lower than the first precision. The electronic device 310 captures the second image of the eyeball 340 with a lower second precision with the camera 320. Such a second image does not contain biometric information of the user 140 due to the lower precision. If such a second image is used, for example, eye tracking, not only the image processing efficiency is improved, but also the risk of user data leakage is reduced.

In summary, according to various embodiments of the present disclosure, biometric-based identity verification is performed on the user, and after the identity verification is passed, the use of the device or the requested data is provided to achieve the first level of protection for the user data. After the identity verification succeeds, the image containing the biometric information is deleted, even if the device is lost, user data leakage does not occur. Further, images with different precisions are obtained for different functional applications, so that the image processing efficiency can be improved. In some embodiments, a lower-precision image is used for other functions other than identity verification, which do not threaten the security of user data during such an image processing or after storage, achieving a second level of protection for user data.

### Example Processes

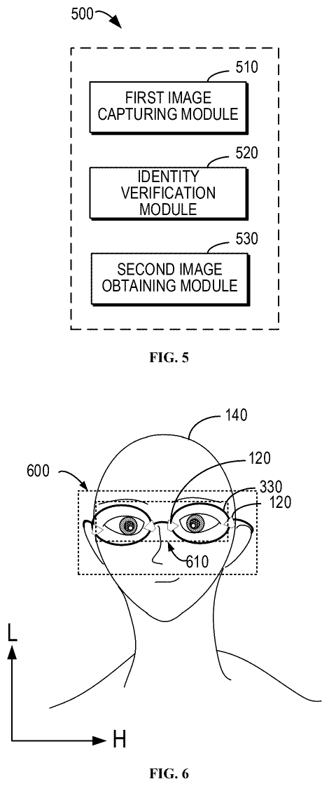

FIG. 4 illustrates a flowchart of a process 400 for signal processing according to some embodiments of the present disclosure. The process 400 may be implemented at the electronic device 110. The process 400 is described below with reference to FIG. 1.

At block 410, the electronic device 110 captures, using a camera, a first image for a first portion of a user, the first image having a first precision.

At block 420, the electronic device 110 performs biometric-based identity verification on the user using information of the first portion included in the first image.

At block 430, the electronic device 110 in response to the identity verification being passed, obtains at least one second image for a second portion of the user, the at least one second image having a second precision different from the first precision.

In some embodiments, information of a predetermined type is present in one of the first image and the second image, and information of the predetermined type is absent in the other one of the first image and the second image.

In some embodiments, the information of the predetermined type is information for biometric identification of the user.

In some embodiments, in order to obtain the at least one second image for the second portion of the user, the electronic device 110 captures, using the camera, at least one original image for the second portion of the user with the first precision; and generates the at least one second image by sampling the at least one original image to change a precision of the at least one original image.

In some embodiments, to obtain the at least one second image for the second portion of the user, the electronic device 110 configures the camera to capture the at least one second image with the second precision.

In some embodiments, the first image and the second image have different resolutions.

In some embodiments, the electronic device 110 in response to the identity verification being passed, deletes the first image.

In some embodiments, the camera is arranged in a wearable device and arranged adjacent to an edge of a lens of the wearable device.

In some embodiments, the second precision is lower than the first precision.

### Example Apparatus and Device

FIG. 5 illustrates a schematic structural block diagram of an apparatus 500 for signal processing according to some embodiments of the present disclosure. The apparatus 500 may be implemented as or included in the electronic device 110. The various modules/components in the apparatus 500 may be implemented by hardware, software, firmware, or any combination thereof.

As shown, the apparatus 500 includes a first image capturing module 510 configured to capture, using a camera, a first image for a first portion of a user, the first image having a first precision. The apparatus 500 further includes an identity verification module 520 configured to perform biometric-based identity verification on the user using information of the first portion included in the first image. The apparatus 500 further includes a second image obtaining module 530 configured to in response to the identity verification being passed, obtain at least one second image for a second portion of the user, the at least one second image having a second precision different from the first precision.

In some embodiments, information of a predetermined type is present in one of the first image and the second image, and information of the predetermined type is absent in the other one of the first image and the second image.

In some embodiments, the information of the predetermined type is information for biometric identification of the user.

In some embodiments, the second image obtaining module 530 is further configured to capture, using the camera, at least one original image for the second portion of the user with the first precision; and generate the at least one second image by sampling the at least one original image to change a precision of the at least one original image.

In some embodiments, the two image obtaining module 530 is further configured to configure the camera to capture the at least one second image with the second precision.

In some embodiments, the first image and the second image have different resolutions.

In some embodiments, the apparatus 500 further includes a deletion module configured to in response to the identity verification being passed, delete the first image.

In some embodiments, the camera is arranged in a wearable device and arranged adjacent to an edge of a lens of the wearable device.

In some embodiments, the second precision is lower than the first precision.

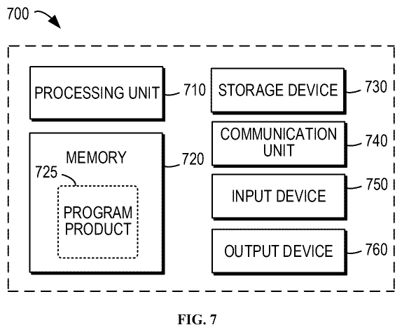

FIG. 6 illustrates a schematic diagram of a wearable device 600 according to some embodiments of the present disclosure. The various modules/components in the wearable device 600 may be implemented by hardware, software, firmware, or any combination thereof. It should be understood that the wearable device 600 illustrated in FIG. 6 is merely an example and should not constitute any limitation on the functionality and scope of the embodiments described herein.

As shown, the wearable device 600 includes at least one camera 120 configured to capture a first image for a first portion and at least one second image for a second portion of the user 140. The wearable device 600 further includes a controller 610 configured to perform the method 500 as described above. The controller 610 may be an electronic device 110 implemented in a controller manner or included in the electronic device 110.

In some embodiments, the wearable device 600 further includes at least one lens 330. The at least one camera 120 is arranged adjacent to an edge of a lens of the at least one lens 330.

In some embodiments, the camera 120 may be arranged adjacent to an end of the lens 330 along a horizontal axis H of the lens 330. If the user 140 wears the wearable device 600, the direction of the horizontal axis H is substantially consistent with the connection direction of the two eyes of the user. In the case where the lens 330 is commonly similar to an ellipse, the horizontal axis H may generally be the major axis of the ellipse.

In one example, the wearable device 600 includes a camera 120 arranged at a proximal end of the lens 330 along the horizontal axis H of the lens 330. At this point, in the case that the user 140 wears the wearable device 600, the camera 120 would be positioned adjacent to the nose bridge of the user 140. In some embodiments, the camera 120 may be at a position of the nose of the user 140, such as a position between the nose bridge and an eye corner of the user.

In the example of FIG. 6, the wearable device 600 includes two cameras 120 arranged along the horizontal axis H of the lens 330 at both the proximal and distal ends of the lens 330. At this point, in the case that the user 140 wears the wearable device 600, the camera 120 at the proximal end would be positioned adjacent to the nose bridge of the user 140, while the camera 120 at the distal end would be positioned adjacent to the temporal portion (i.e., temple) of the user 140. Since the acquisition angle for the eye image is relatively broad at the nose and the temporal portion, in such an embodiment, by arranging the camera in such a position, higher quality eye images can be better captured, thereby improving the precision for eye position determination and eye tracking.

Of course, this arrangement is not necessary. In some other embodiments, the camera 120 may also be arranged adjacent to an end of the lens 330 along a longitudinal axis L of the lens 330. For example, the longitudinal axis L is substantially perpendicular to the horizontal axis H. As shown in FIG. 6, in such an embodiment, the camera 120 is arranged adjacent to the upper side and/or the underside of the lens 330 along the longitudinal axis L of the lens 330.

It should be understood that the camera 120 of the wearable device 600 in the present disclosure is not limited to the arrangement shown in the embodiment in FIG. 6. Any modification or adjustment may be made to the position and/or number of cameras 120 without departing from the principles of the present disclosure.

FIG. 7 illustrates a block diagram of a computing device 700 in which one or more embodiments of the present disclosure may be implemented. It should be understood that the computing device 700 shown in FIG. 7 is merely an example and should not constitute any limitation on the functionality and scope of the embodiments described herein. The computing device 700 shown in FIG. 7 may be configured to implement the electronic device 110 in FIG. 1 or may be configured to implement the electronic device 110 and the camera 120 in FIG. 1.

As shown in FIG. 7, the computing device 700 is in the form of a general computing device. The components of computing device 700 may include, but are not limited to, one or more processors or processing units 710, a memory 720, a storage device 730, one or more communication units 740, one or more input devices 750, and one or more output devices 760. The processing unit 710 may be an actual or virtual processor and can execute various processes based on the programs stored in the memory 720. In a multiprocessor system, multiple processing units execute computer executable instructions in parallel to improve the parallel processing capability of the computing device 700.

The computing device 700 typically includes multiple computer storage medium. Such medium may be any available medium that is accessible to the computing device 700, including but not limited to volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 730 may be any removable or non-removable medium and may include a machine readable medium such as a flash drive, a disk, or any other medium, which may be used to store information and/or data (such as training data for training) and may be accessed within the computing device 700.

The computing device 700 may further include additional removable/non-removable, volatile/non-volatile storage medium. Although not shown in FIG. 7, a disk drive for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 720 may include a computer program product 725, which has one or more program units configured to perform various methods or acts of various embodiments of the present disclosure.

The communication unit 740 communicates with a further computing device through the communication medium. In addition, functions of components in the computing device 700 may be implemented by a single computing cluster or multiple computing machines, which can communicate through a communication connection. Therefore, the computing device 700 may be operated in a networking environment using a logical connection with one or more other servers, a network personal computer (PC), or another network node.

The input device 750 may be one or more input devices, such as a mouse, a keyboard, a trackball, etc. The output device 760 may be one or more output devices, such as a display, a speaker, a printer, etc. The computing device 700 may also communicate with one or more external devices (not shown) through the communication unit 740 as required. The external device, such as a storage device, a display device, etc., communicate with one or more devices that enable users to interact with the computing device 700, or communicate with any device (for example, a network card, a modem, etc.) that makes the computing device 700 communicate with one or more other electronic devices. Such communication may be executed via an input/output (I/O) interface (not shown).

According to example implementation of the present disclosure, a computer readable storage medium is provided, on which computer executable instructions are stored, wherein the computer executable instructions are executed by the processor to implement the method described above. According to example implementation of the present disclosure, a computer program product is also provided. The computer program product is tangibly stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various embodiments disclosed herein.

1. A method of signal processing, comprising:
capturing, using a camera, a first image for a first portion of a user, the first image having a first precision;
performing biometric-based identity verification on the user using information of the first portion comprised in the first image; and
in response to the identity verification being passed, obtaining at least one second image for a second portion of the user, the at least one second image having a second precision different from the first precision.

2. The method of claim 1, wherein information of a predetermined type is present in one of the first image and the second image, and information of the predetermined type is absent in the other one of the first image and the second image.

3. The method of claim 2, wherein the information of the predetermined type is information for biometric identification of the user.

4. The method of claim 1, wherein obtaining the at least one second image for the second portion of the user comprises:
capturing, using the camera, at least one original image for the second portion of the user with the first precision; and
generating the at least one second image by sampling the at least one original image to change a precision of the at least one original image.

5. The method of claim 1, wherein obtaining the at least one second image for the second portion of the user comprises:
configuring the camera to capture the at least one second image with the second precision.

6. The method of claim 1, wherein the first image and the second image have different resolutions.

7. The method of claim 1, further comprising:
in response to the identity verification being passed, deleting the first image.

8. The method of claim 1, wherein the camera is arranged in a wearable device and arranged adjacent to an edge of a lens of the wearable device.

9. The method of claim 1, wherein the second precision is lower than the first precision.

10-12. (canceled)

13. A wearable device, comprising:
a camera; and
a controller configured to:
capture, using a camera, a first image for a first portion of a user, the first image having a first precision;
perform biometric-based identity verification on the user using information of the first portion comprised in the first image; and
in response to the identity verification being passed, obtain at least one second image for a second portion of the user, the at least one second image having a second precision different from the first precision.

14. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
capturing, using a camera, a first image for a first portion of a user, the first image having a first precision;
performing biometric-based identity verification on the user using information of the first portion comprised in the first image; and
in response to the identity verification being passed, obtaining at least one second image for a second portion of the user, the at least one second image having a second precision different from the first precision.

15. (canceled)

16. The wearable device of claim 13, wherein the controller is further configured to:
in response to the identity verification being passed, delete the first image.

17. The electronic device of claim 14, wherein information of a predetermined type is present in one of the first image and the second image, and information of the predetermined type is absent in the other one of the first image and the second image.

18. The electronic device of claim 17, wherein the information of the predetermined type is information for biometric identification of the user.

19. The electronic device of claim 14, wherein obtaining the at least one second image for the second portion of the user comprises:
capturing, using the camera, at least one original image for the second portion of the user with the first precision; and
generating the at least one second image by sampling the at least one original image to change a precision of the at least one original image.

20. The electronic device of claim 14, wherein obtaining the at least one second image for the second portion of the user comprises:
configuring the camera to capture the at least one second image with the second precision.

21. The electronic device of claim 14, wherein the first image and the second image have different resolutions.

22. The electronic device of claim 14, wherein the acts further comprise:
in response to the identity verification being passed, deleting the first image.

23. The electronic device of claim 14, wherein the camera is arranged in a wearable device and arranged adjacent to an edge of a lens of the wearable device.

24. The electronic device of claim 14, wherein the second precision is lower than the first precision.
